(19) United States
(12) Patent Application Publication
(10) Pub. No.: US 2006/0118653 A1
(43) Pub. Date: Jun. 8, 2006

(54) Ground contacting boom height control system

(75) Inventor: Montgomery Stanislaus Shivak, Stockholm (CA)

Correspondence Address: ALTERA LAW GROUP, LLC, 6500 CITY WEST PARKWAY, SUITE 100, MINNEAPOLIS, MN, 55344-7704, US

(73) Assignee: Raven Industries, Inc., Sioux Falls, SD (US)

(21) Appl. No.: 11/184,107

(22) Filed: Jul. 19, 2005

(30) Foreign Application Priority Data
Nov. 5, 2004 (CA) 2487184

(51) Int. Cl. B05B 1/20

(52) U.S. Cl. 239/166

(57) ABSTRACT

A ground-contacting boom height control system for a vehicle comprising a frame supported for rolling movement along the ground; an operator cab for supporting an operator of the vehicle therein; a pair of boom structures extending laterally outward from opposing sides of the frame for pivotal movement up and down relative to the frame; a lift cylinder coupled between each boom structure and the frame for lifting the boom structures, each lift cylinder including a lifting circuit for lifting the boom when receiving hydraulic fluid under pressure from a conventional valve control and a lowering circuit for lowering the boom when receiving hydraulic fluid under pressure from a conventional valve control, and a conventional hydraulic circuit including a reservoir and a pump for supplying the hydraulic fluid under pressure from the reservoir to the lift cylinders.

### RELATED APPLICATIONS

This application claims priority to Canadian Patent Application Number 2,487,184 filed Nov. 5, 2004.

### FIELD OF THE INVENTION

The present invention relates to agricultural applicators for applying agricultural materials such as fertilizer, herbicides, and pesticides on fields, as well as for various industrial and commercial uses, and in particular relates to a control system for the laterally extending booms on such applicators.

### BACKGROUND

When spraying fields in agricultural applications, it is common to use a sprayer of the type which comprises a wheeled vehicle including a pair of boom structures spanning laterally outwardly therefrom. Each boom is typically pivoted on the frame of the vehicle for up and down movement relative to the vehicle to protect the booms from collision with the ground. The vehicles commonly include a tank and spray equipment spanning the booms for spraying materials in the tank into the fields. A lift cylinder is typically coupled between each boom and the vehicle frame to control lifting of the boom structures using hydraulics. Accordingly a typical hydraulic system including a pump and reservoir are provided.

Many efforts have been made to protect the booms from collision with the ground while also maintaining the booms close enough to the ground for effective application of the tank materials to a crop on the fields. Canadian Patent Application 2,444,690 discloses a suspended floating sprayer boom in which a gauge member is support on each boom for rolling movement along the ground. Active control of the pressure in the lifting cylinders of the boom structures is provided to maintain a constant controlled pressure on the gauge member as the gauge member follows the ground. Although this configuration provides some improvement over many prior art systems, it is quite limited as adjustment of the set point pressure of the active control system requires an operator to exit the operator cab and manually adjust the set point at the control valves. As it is common to encounter varying field conditions with a given sprayer, a single set point pressure will not provide optimum response of the boom in all such varied conditions. Another significant problem with this system occurs in the event of some hydraulic failure. Due to the gauge members which are supported for rolling movement along the ground, it is typically not visible to the operator when lower pressure occurs as the gauge members maintain the height of the boom structures relative to the ground even under lower pressure conditions. This can result in too much drag on the boom structures eventually resulting in breakage.

Another control system for agricultural sprayer booms has been developed by Norac and uses ultrasonic sensors on the boom to measure height from the ground along with a controller for adjusting hydraulic pressure in the lift cylinders on an attempt to maintain the boom structures at a consistent height above the ground despite varying elevation as the sprayer travels across the ground. Specifically the controller operates the conventional proportional lifting and lowering control valves already in place to operate the lift cylinders. By cycling these solenoids between fully open and fully closed states, pressure can to some degree be controlled but the corrective measures for opening or closing the conventional control valves are only initiated after the boom is typically already moving out of position at a considerable rate. When the lift cylinder is at the proper height, the valves are completely closed. Thus, a significant problem occurs as the conventional valves are required to be operated rapidly, often multiple times per second, causing burnout of the components as they were not intended to be used in this manner. In general the operation is very rough and corrective measures are very jerky. This occurs because when the vehicle is initially displaced by rough terrain, the conventional valves initially are locked in fully closed positions and do not even begin to open until after the momentum of vehicle movement has already been transferred to the booms and the booms have already begun moving quickly out of position. Even when reaction time to open the conventional solenoid valves is only a matter of a few milliseconds, the system is considerable limited as the corrective reaction can only occur after the momentum of the vehicle following ground contours has already been transferred to the booms thus the system is always falling behind the actual movements of the vehicle and the booms. By subsequently overcompensating with increasingly rapid movements and increasingly corrective forces a highly unstable control system results.

### SUMMARY OF THE INVENTION

According to one aspect of the present invention there is provided a boom control system for a vehicle comprising a frame supported for rolling movement along the ground; an operator cab for supporting an operator of the vehicle therein; a pair of boom structures extending laterally outward from opposing sides of the frame for pivotal movement up and down relative to the frame; a lift cylinder coupled between each boom structure and the frame for lifting the boom structures, each lift cylinder including a lifting circuit for lifting the boom when receiving hydraulic fluid under pressure from a conventional valve control and a lowering circuit for lowering the boom when receiving hydraulic fluid under pressure from a conventional valve control, and a conventional hydraulic circuit including a reservoir and a pump for supplying the hydraulic fluid under pressure from the reservoir to the lift cylinders, the system comprising:

a gauge wheel for attachment below each boom structure for pivoting the boom structure up and down relative to the frame as the gauge wheel rides along the ground;

pressure reducing valve means for communication with the lifting circuit of each cylinder and having a set point pressure whereby the pressure reducing valve means maintains a controlled pressure in the lifting circuits substantially at the set point pressure by allowing hydraulic fluid to flow from the lifting circuits to the fluid reservoir when lowering of the boom by the gauge wheel increases hydraulic pressure at the lifting circuits above the set point pressure and by allowing hydraulic fluid to flow from the pump to the lifting circuits under pressure when raising of the boom by the gauge wheel decreases hydraulic pressure at the lifting circuits below the set point pressure;

switch means for selectively disconnecting the pressure reducing valve means from the lifting circuits to allow normal operation of lifting circuits by the conventional valve control;

biasing means controlling the set point pressure of the pressure reducing valve means; and

control means for being supported in the operator cab for controlling a biasing force applied to the pressure reducing valve means by the biasing means such that the set point pressure of the pressure reducing valve means can be adjusted from the operator cab.

According to a second aspect of the present invention there is provided a boom control system for a vehicle comprising a frame supported for rolling movement along the ground; an operator cab for supporting an operator of the vehicle therein; a pair of boom structures extending laterally outward from opposing sides of the frame for pivotal movement up and down relative to the frame; a lift cylinder coupled between each boom structure and the frame for lifting the boom structures, each lift cylinder including a lifting circuit for lifting the boom when receiving hydraulic fluid under pressure from a conventional valve control and a lowering circuit for lowering the boom when receiving hydraulic fluid under pressure from a conventional valve control, and a conventional hydraulic circuit including a reservoir and a pump for supplying the hydraulic fluid under pressure from the reservoir to the lift cylinders, the system comprising:

a gauge wheel for attachment below each boom structure for pivoting the boom structure up and down relative to the frame as the gauge wheel rides along the ground;

pressure reducing valve means for communication with the lifting circuit of each cylinder and having a set point pressure whereby the pressure reducing valve means maintains a controlled pressure in the lifting circuits substantially at the set point pressure by allowing hydraulic fluid to flow from the lifting circuits to the fluid reservoir when lowering of the boom by the gauge wheel increases hydraulic pressure at the lifting circuits above the set point pressure and by allowing hydraulic fluid to flow from the pump to the lifting circuits under pressure when raising of the boom by the gauge wheel decreases hydraulic pressure at the lifting circuits below the set point pressure;

switch means for selectively disconnecting the pressure reducing valve means from the lifting circuits to allow normal operation of lifting circuits by the conventional valve control;

adjustable biasing means controlling the set point pressure of the pressure reducing valve means;

a pressure monitor connected to the lifting circuits between the pressure reducing valve means and the lift cylinders for monitoring the controlled pressure; and

an alarm indicator for being supported in the operator cab for indicating when the controlled pressure falls below a prescribed lower alarm limit.

According to a further aspect of the present invention there is provided a boom control system for a vehicle comprising a frame supported for rolling movement along the ground; an operator cab for supporting an operator of the vehicle therein; a pair of boom structures extending laterally outward from opposing sides of the frame for pivotal movement up and down relative to the frame; a lift cylinder coupled between each boom structure and the frame for lifting the boom structures, each lift cylinder including a lifting circuit for lifting the boom when receiving hydraulic fluid under pressure from a conventional valve control and a lowering circuit for lowering the boom when receiving hydraulic fluid under pressure from a conventional valve control, and a conventional hydraulic circuit including a reservoir and a pump for supplying the hydraulic fluid under pressure from the reservoir to the lift cylinders, the system comprising:

a pair of pressure reducing valve means for communication with the lifting circuits of the lift cylinders respectively, each having a set point pressure whereby the pressure reducing valve means maintains a controlled pressure in the respective lifting circuit substantially at the set point pressure by allowing hydraulic fluid to flow from the lifting circuit to the fluid reservoir when hydraulic pressure in the lifting circuit increases above the set point pressure and by allowing hydraulic fluid to flow from the pump to the lifting circuit under pressure when hydraulic pressure in the lifting circuit decreases below the set point pressure;

switch means for selectively disconnecting the pressure reducing valve means from the lifting circuits to allow normal operation of lifting circuits by the conventional valve control;

elevation monitoring means for monitoring elevation of each boom structure relative to the ground; and

control means for controllably varying the set point pressure of the pressure reducing valve means for maintaining the elevation of the boom structures substantially at a desired elevation level.

In the first embodiment of the present invention, gauge wheels are used with a floating pressure in the lifting circuits for closely following ground contours. In the event that low pressure occurs which is typically not visible to an operator in such a system, an alarm will alert the operator in the cab to prevent continued movement of the sprayer vehicle across the ground which would ultimately result in breakage of the boom structures. In addition the present invention provides a system whereby when various different conditions of terrain are encountered by an operator, controls are provided directly in the cab to adjust the reaction speed of the control system by adjusting downward force which is permitted on the gauge wheels.

In a further embodiment, a pressure reducing and pressure relieving valve is provided in combination with ultrasonic height sensors which gauge elevation of the boom relative to the ground. This configuration is most effective when using a controller which is able to controllably vary the set point pressure of a pressure reducing valve depending upon the elevation sensed by the ultrasonic devices. The boom control system is particularly advantageous over the prior art systems due to the use of a pressure reducing and pressure relieving valve operating each lift cylinder independently because the momentum of the vehicle suddenly changing direction due to ground contours is not immediately transferred to the booms or from one boom to another but rather a significant portion of the shock is absorbed by the pressure reducing and pressure relieving valves. Only the set point pressure of the pressure reducing and pressure relieving valves are adjusted and no valves are rapidly cycled between fully open and fully closed positions so that the valve itself is floating to gradually balance and remove violent corrective measures of the prior art systems. By avoiding use of digital valves moveable between fully open and fully closed positions, the boom is not locked in its set position but rather floats with the valve to avoid delayed and overcompensating corrective measures of the prior art.

The system according to the present invention is faster because the valve to the lift cylinder is always open, the pump is charged to the cylinder and hoses, and the boom is on the verge of moving. A special hydraulic cartridge before the open valve controls the pressure going through the valve and to the cylinder. Just the right amount will hold the boom still. A very slight increase will start a smooth travel up; a very slight decrease will start a smooth travel down. The maximum up and down speed is adjustable on the go, depending on the conditions.

In one embodiment, system may use a tiny electric motor and gearbox to adjust the cartridge to choose the correct pressure. Alternatively, in a further embodiment, the system will use a pressure-controlling device that can be controlled electronically by the processor and can make adjustments instantly. There is no mechanical time delay created by opening and closing valves as the valve is open and the pump, hose and cylinder are all charged and on the verge of moving. The valve to the cylinder is always open. An electronic pressure-controlling device will instantly change oil pressure going to the open valve to the lift cylinder.

The second embodiment will raise and lower the booms without wheels. It will be a fully suspended boom again. The processing will be completely different as the boom is controlled by changing oil pressure and the hydraulic circuit is never closed. The manner in which the booms are moved has not been done before.

Desirable features include the ability to set the static pressure, the ability to adjust how fast the boom will travel up and down, the ability to adjust the amount of acceptable error in inches, and the ability to make such adjustments “on the go” from the cab. This enables an operator to find the line between speed and stability. Additional features include a “too low” over ride “pot”, a “too low” alarm, a “too high” alarm and a low pressure alarm. The present control system deals with body roll, cushions the ride on the boom, replaces the need for an accumulator and applies static pressure when the boom is in the dead band.

Various embodiments of the invention will now be described in conjunction with the accompanying drawings in which:

### BRIEF DESCRIPTION OF THE DRAWINGS

FIG. 1 is a rear elevational schematic view of a sprayer according to a first embodiment of the present invention.

FIG. 2 is a schematic view of the components of the control system according to FIG. 1.

FIG. 3 is rear elevational schematic view of a sprayer incorporating a second embodiment of the control system therein.

FIG. 4 is a schematic view of the second embodiment of the control system.

FIG. 5 is a plan view of the controller of the second embodiment.

FIG. 6 is a graph illustrating the various control limits used by the controller according to FIG. 5.

### In the drawings like characters of reference indicate corresponding parts in the different figures.

### DETAILED DESCRIPTION

Referring to the accompanying figures there is illustrated a boom control system generally indicated by reference numeral 10. The system 10 is particularly suited for a vehicle supporting two boom structures 12 spanning laterally outwardly therefrom, for example as in an agricultural sprayer 14.

The sprayer 14 generally comprises a frame 16 supported for rolling movement along the ground. An operator cab is provided on the vehicle for housing an operator which drives the sprayer. The sprayer further includes a tank 18 at the rear thereof along with applicator equipment 20 spanning the boom for spraying the material from the tank 18 onto the field. The boom structures 12 are pivotally supported on the frame of the vehicle for up and down movement about a generally horizontal axis extending in the longitudinal direction of the vehicle. A lift cylinder 22 is coupled between each boom structure and the frame of the vehicle to controllably vary the height of the boom structures depending upon hydraulic fluid received therein. A conventional hydraulic system is provided including a pump 24 which draws hydraulic fluid from a reservoir 26 for pumping under pressure to the lift cylinders 22. A conventional up and down valve controller 28 receives fluid under pressure from the pump and returns excess fluid back to the reservoir 26. The control 28 selectively couples the pressure line from the pump 24 to either of the lifting circuits 30 connected to the lift cylinders 22 in a manner to lift the booms when receiving hydraulic fluid pressure therein. The controller 28 also selectively controls connection of the pump to lowering circuits 32 connected to the lift cylinders 22 in a manner to lower the boom structures when receiving fluid under pressure therein. In each instance when the pump output is connected to one of the lifting or lowering circuits of the lift cylinders 22 respectively, the opposing circuits are connected to the reservoir 26 through the control 28 to effect operation of the hydraulic piston cylinders 22 in a conventional manner.

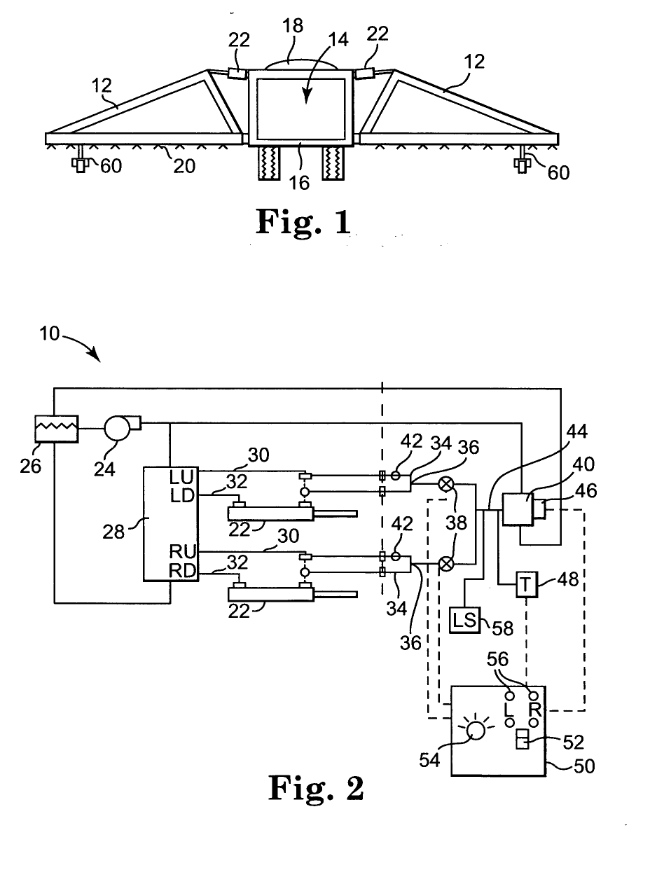

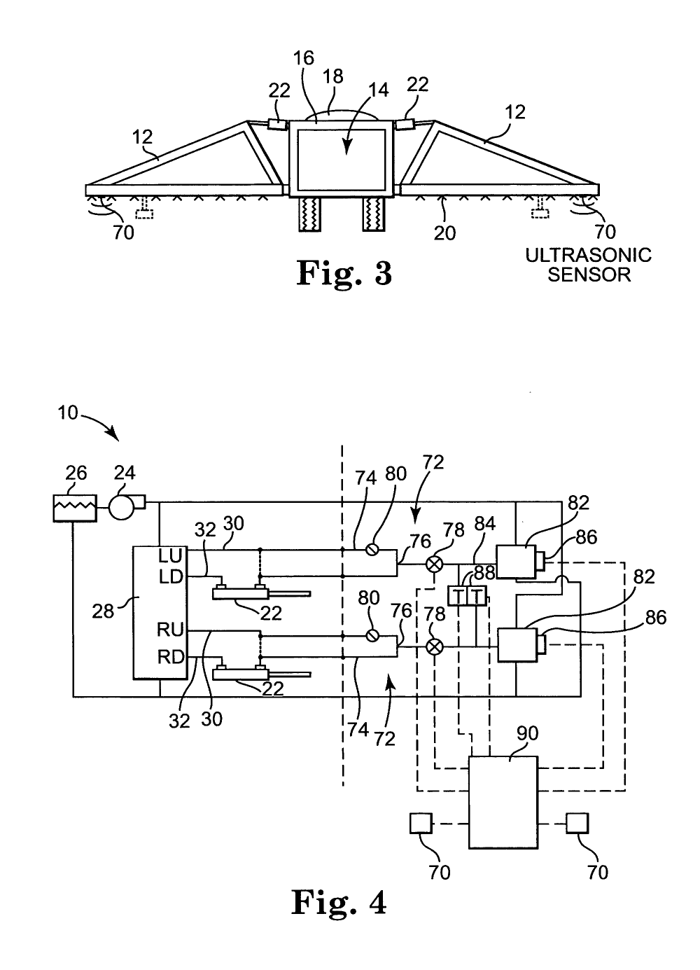

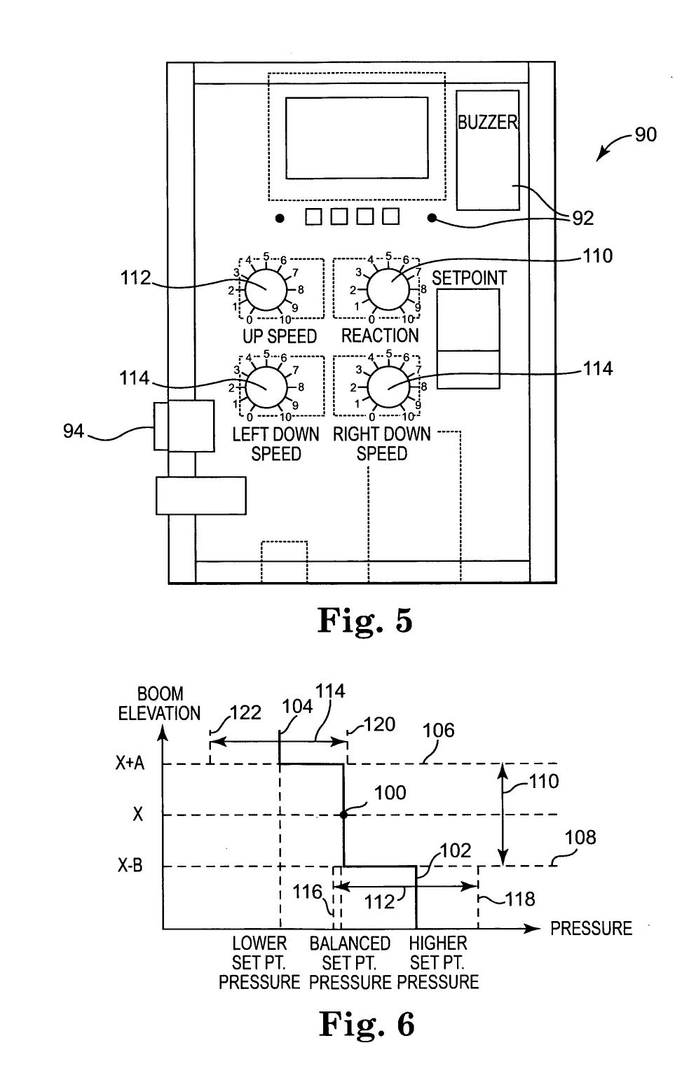

Turning now to the first embodiment as illustrated in FIGS. 1 and 2, a controlled pressure circuit is provided for connection to the lifting circuits 30 of both lift cylinders 22. As shown in FIG. 2, the components of the control system 10 are illustrated on the right side of the dashed line.

Both the left and right side lifting circuits 30 are interrupted by a respective controlled branch line 34 connected in series therewith. The controlled branch line 34 connects using an internal tee 36 to an activation valve 38. The activation valve 38 when opened connects the branched line 34 through the tee 36 to the output of a pressure reducing and pressure relieving valve 40. The active valves 38 of both left and right side lifting circuits 30 are commonly connected to the valve 40.

Flow restrictors 42 normally connected within lifting circuits 30 are relocated to the controlled branch line 34 for both left and right side boom structures at a location which is upstream from the respective tee 36 so that the flow restrictors 42 continue to act in their conventional manner when the activation valves 38 are closed and the lifting circuits 30 flow through the controlled branch lines 34 in series therewith in a conventional manner. Alternatively when the activation valves 38 are opened, the pressure controlled output of the pressure reducing and pressure relieving valve 40 has unrestricted communication with the lift cylinders 22. The branch line 34 down stream from each respective tee 36 is larger in cross sectional area than upstream from the tee 36 for accommodating larger pressure controlled flows from the valve 40.

The pressure reducing and pressure relieving valve 40 receives hydraulic fluid under pressure from the pump and returns excess fluid back to the reservoir. The controlled pressure line 44 comprising the output of the valve 40 is in direct communication with the lifting port on the lift cylinders 22 coupling the lifting circuits 30 thereto. The valve 40 has a biasing mechanism 46 integrally supported therein which controls the balanced set point pressure of the valves. Adjustment of the biasing mechanism force applied to the valve thus adjusts the set point pressure at which the valve will balance. A transducer 48 is coupled to the controlled pressure line 44 at the output of the valve 40 to monitor pressure being controlled.

A controller 50 is arranged for being supported within the operator cab of the sprayer vehicle to control operation of the control system. An enabling control switch 52 is used to switch the activation valves 38 simultaneously between their open and closed states for enabling and subsequently disabling the system. A scaled controller switch 54 on the control panel 50 provides control to the operator of the biasing force applied by the biasing mechanism 46 which thus in turn adjusts the set point pressure. If different field conditions are encountered, the operator can quickly adjust the force applied to the boom by the lifting cylinders to in turn adjust the performance of the system. The controller further includes an alarm coupled to the transducer 48 which provides an indication to the operator if the pressure in the lines is too low or too high or if the system is not turned on when it should be.

A load sensing line 58 is also coupled to the output of the pressure reducing and pressure relieving valve 40 for relaying a pressure condition back to the pump in an open center hydraulic system.

As shown in FIG. 1, in the first embodiment the control system also includes a pair of gauge wheels 60 which support the boom structures respectively thereabove for rolling movement above the ground. One gauge wheel is provided on each boom structure and generally comprises a post adjustably connected to the boom structure and supporting a wheel at a bottom end thereof. In operation, the set point pressure of the pressure reducing and pressure relieving valve is set so that only a few pound of pressure are applied to each of the gauge wheels 60. The sprayer is then operated in its normal manner while the gauge wheels 60 roll over the various contours of ground.

When the ground lowers in elevation, the boom is lowered with the gauge wheel associated with that particular boom structure which results in an increase in pressure in the lifting circuit. The valve 40 automatically floats to a relieving position which relieves pressure back to the reservoir of the hydraulic system until the pressure approaches the set point pressure again. Alternatively when elevation of the ground suddenly increases, the gauge wheel of the associated one of the boom structures raises in elevation causing the boom structure to be raised and subsequently pressure to be decreased. The valve 40 in this instance automatically floats to a position allowing more pressurized fluid from the pump to be introduced into the lifting circuit to keep the pressure substantially constant at the set point pressure.

Turning now to FIG. 3 a further embodiment of the control system 10 is illustrated in which each boom structure carries an ultrasonic sensor 70 thereon towards the free ends thereof. In a typical configuration, no gauge wheels 60 are provided. The ultrasonic sensors 70 serve to measure distance from the boom to the ground to use this information to maintain the boom height substantially constant relative to the ground by varying a control pressure of the booms alone.

The control system 10 in this instance includes two parallel controlled pressure circuits generally indicated by reference numeral 72. Each control circuit includes a branched line 74 which connects in series with a respective one of the lifting circuits 30 controlling a respective one of the lift cylinders 22. A tee 76 is provided in the branched line 74 to connect to an activation valve 78. Similarly to the previous embodiment flow restrictors 80 normally located at the lifting ports of the lift cylinders are located upstream of tee connectors 76 so as to only provide restriction to the conventional lifting circuit components while the activator valve is unrestricted in its communication with the lifting circuit and lift cylinder.

When the system is operating, the activator valves 78 are always opened and in communication with the output of a respective one of the pair of pressure reducing and pressure relieving valves 82 belonging to the pair of controlled pressure circuits respectively.

As similarly described in the previous embodiment, each pressure reducing and pressure relieving valve 82 receives pressure under fluid from the pump and returns excess fluid back to the reservoir. A controlled pressure line 84 connects to the lifting port of the lift cylinder.

A biasing mechanism 86 is provided on each of the valves 82 which generally comprises a solenoid type control which adjusts the biasing force applied to the valve by adjusting the voltage and subsequently the magnetic force applied by the solenoid to the valve. The biasing force applied by the biasing mechanism 86 to the valve 82 can thus be instantaneously set to a prescribed force corresponding to a prescribed set point pressure of the valve 82.

A transducer 88 is coupled to the controlled output line 84 for monitoring the actual pressure in the controlled line. A control panel 90 is again provided for mounting in the operator cab and similarly includes an alarm 92 which monitors pressure using the transducer 88. The alarm is activated if pressure in the controlled output line of either valve 82 is too low or too high beyond respective upper alarm and lower alarm limits. An activation control switch 94 controls opening and closing of the activation valves for selectively disconnecting the components of the control system from the conventional valve controls of the lift cylinders.

The control panel 90 includes a microprocessor configured for controllably varying the set point pressure of each pressure reducing and pressure relieving valve 82 independently of one another to in turn maintain the boom structures at a substantially desired height above the ground.

Turning now to FIG. 6, the control panel 90 defines a balanced set point pressure 100, a higher set point pressure 102 and a lower set point pressure 104. The control panel further defines a prescribed upper height limit 106 and prescribed lower limit height 108. The prescribed upper height limit 106 is the highest elevation that the boom is permitted to reach before a corrective measure is initiated while the prescribed lower height limit is in turn the lowest elevation that the boom is permitted relative to the ground before a corrective measure is initiated. The values of the upper and lower height limits 106 and 108 are readily adjustable by the control panel 90 using the reaction dial 110 which in effect controls the overall the amount of error between the two limits which is permitted before corrective measures are initiated.

The balanced set point pressure 100 is set individually for each boom structure and intended to be the value of biasing force required so that the control pressure which results balances height of the boom suspended above the ground at the ideal prefer height when the sprayer is static on horizontal ground.

The higher set point pressure 102 is a set point which corresponds to an adjusted biasing force which would result in a greater pressure and in turn a greater boom elevation if permitted to balance at that set point. The lower set point pressure 104 in turn corresponds to a lower biasing force set on each valve 82 which would result in a lower pressure and a lower boom elevation if the valve were permitted to balance at this lower set point pressure.

Each of the higher and lower set point pressures is adjustable by respective control dials 112 and 114 on the control panel. A common control dial 112 is provided to adjust both higher set point pressures as a greater margin of error is permitted when lifting the boom structures, however each lower set point pressure 104 includes its own respective control dial 114 corresponding to the respective boom structure. Each dial permits the set point pressure to be varied on a scale between zero and ten in which these points on the dial are initially set for the respective boom structures. The higher set point pressure preferably includes as its lowest value 116 of the scale a point which is slightly below the balance set point while the opposing end of the scale 118 corresponds to considerably greater pressure.

Similarly the lower set point pressure limits of the scale as defined on the control dials 114 are set so that the lowest value on the scale 120 is slightly above the balanced set point pressure with the opposing end of the scale 122 being substantially lower in pressure than the balanced set point pressure. In this configuration the control panel controllably varies the set point pressure of each pressure reducing and pressure relieving valve between a higher set point pressure, a lower set point pressure and a balanced set point pressure.

The set point pressure is set at the balanced point when elevation of the boom is between the lower height limit and the upper height limit. When the boom structure falls below the lower height limit the higher set point pressure is automatically selected until the boom returns to an elevation between the height limits. Similarly when the elevation of the respective boom structure raises above the prescribed upper height limit, the set point pressure is set to the lower set point pressure until the boom again returns to an elevation between the height limits.

In each instance, the valves 82 instantaneously react to changes in momentum of the boom structure which result in changes in pressure unlike prior art systems in which valves which are cycled between fully open and fully close positions are initially locked and do not respond to fluctuating pressures as a result of shifts in momentum of the boom structures. Instead of prior art corrective measures in which a valve is fully opened exposing the lifting circuit to a surge of full pressure, the present invention instead merely adjusts the set point pressure to a desired higher or lower set point pressure which is a controlled pressure which can be controllably varied for varying the reaction time of the system and the severity of the reactions.

Adjusting the values of the prescribed upper and lower height limits avoids unnecessary corrections to maintain stability within the system. In summary, the pressure reducing and pressure relieving valves absorb shocks from momentary shifts in momentum without overreacting as any reactive and corrective measures by the system only include adjustments of controlled pressure and only controlled pressure lines are coupled to the lifting circuits as opposed to fully dumping the lifting circuits to the reservoir or fully charging them with pressure directly from the pump when control valves of the type which are fully open or fully closed are used as in the prior art.

In further embodiments, the guide wheel 60 maybe used in addition to the control systems of the second embodiment. In this instance the height limit is set just below the actual height maintained by the gauge wheels so that they system keeps a slight pressure on the wheels with a smooth transition into a lowering condition in the event that the wheels are lifted of the ground by varying elevation and ground contours.

Since various modifications an be made in my invention as herein above described, and many apparently widely different embodiments of same made within the spirit and scope of the claims without department from such spirit and scope, it is intended that all matter contained in the accompanying specification shall be interpreted as illustrative only and not in a limiting sense.

1. A boom control system for a vehicle comprising a frame supported for rolling movement along the ground; an operator cab for supporting an operator of the vehicle therein; a pair of boom structures extending laterally outward from opposing sides of the frame for pivotal movement up and down relative to the frame; a lift cylinder coupled between each boom structure and the frame for lifting the boom structures, each lift cylinder including a lifting circuit for lifting the boom when receiving hydraulic fluid under pressure from a conventional valve control and a lowering circuit for lowering the boom when receiving hydraulic fluid under pressure from a conventional valve control, and a conventional hydraulic circuit including a reservoir and a pump for supplying the hydraulic fluid under pressure from the reservoir to the lift cylinders, the system comprising:
a gauge wheel for attachment below each boom structure for pivoting the boom structure up and down relative to the frame as the gauge wheel rides along the ground;
a pressure reducing valve for communication with the lifting circuit of each cylinder and having a set point pressure whereby the pressure reducing valve maintains a controlled pressure in the lifting circuits substantially at the set point pressure by allowing hydraulic fluid to flow from the lifting circuits to the fluid reservoir when lowering of the boom by the gauge wheel increases hydraulic pressure at the lifting circuits above the set point pressure and by allowing hydraulic fluid to flow from the pump to the lifting circuits under pressure when raising of the boom by the gauge wheel decreases hydraulic pressure at the lifting circuits below the set point pressure;
a switch for selectively disconnecting the pressure reducing valve from the lifting circuits to allow normal operation of the lifting circuits by the conventional valve control;
a biasing mechanism for balancing the pressure reducing valve at the set point pressure; and
a controller for being supported in the operator cab for controlling a biasing force applied to the pressure reducing valve by the biasing mechanism such that the set point pressure of the pressure reducing valve can be adjusted from the operator cab.

2. The system according to claim 1 wherein a flow restrictor is provided in series with each lifting circuit upstream from communication of the pressure reducing valve with the lifting circuits.

3. The system according to claim 1 wherein there is provided a pressure monitor in communication with the lifting circuits for indicating to an operator if pressure falls below a lower alarm limit.

4. A boom control system for a vehicle comprising a frame supported for rolling movement along the ground; an operator cab for supporting an operator of the vehicle therein; a pair of boom structures extending laterally outward from opposing sides of the frame for pivotal movement up and down relative to the frame; a lift cylinder coupled between each boom structure and the frame for lifting the boom structures, each lift cylinder including a lifting circuit for lifting the boom when receiving hydraulic fluid under pressure from a conventional valve control and a lowering circuit for lowering the boom when receiving hydraulic fluid under pressure from a conventional valve control, and a conventional hydraulic circuit including a reservoir and a pump for supplying the hydraulic fluid under pressure from the reservoir to the lift cylinders, the system comprising:
a gauge wheel for attachment below each boom structure for pivoting the boom structure up and down relative to the frame as the gauge wheel rides along the ground;
a pressure reducing valve for communication with the lifting circuit of each cylinder and having a set point pressure whereby the pressure reducing valve maintains a controlled pressure in the lifting circuits substantially at the set point pressure by allowing hydraulic fluid to flow from the lifting circuits to the fluid reservoir when lowering of the boom by the gauge wheel increases hydraulic pressure at the lifting circuits above the set point pressure and by allowing hydraulic fluid to flow from the pump to the lifting circuits under pressure when raising of the boom by the gauge wheel decreases hydraulic pressure at the lifting circuits below the set point pressure;
a switch for selectively disconnecting the pressure reducing valve from the lifting circuits to allow normal operation of the lifting circuits by the conventional valve control;
an adjustable biasing mechanism for balancing the pressure reducing valve at the set point pressure;
a pressure monitor connected to the lifting circuits between the pressure reducing valve and the lift cylinders for monitoring the controlled pressure; and
an alarm indicator for being supported in the operator cab for indicating when the controlled pressure falls below a prescribed lower alarm limit.

5. The system according to claim 4 wherein the alarm monitors the switch for indicating to the operator when the system is not functioning.

6. The system according to claim 4 wherein there is provided a flow restrictor connected in series with each lifting circuit upstream from communication of the lifting circuit with the pressure reducing valve.

7. A boom control system for a vehicle comprising a frame supported for rolling movement along the ground; an operator cab for supporting an operator of the vehicle therein; a pair of boom structures extending laterally outward from opposing sides of the frame for pivotal movement up and down relative to the frame; a lift cylinder coupled between each boom structure and the frame for lifting the boom structures, each lift cylinder including a lifting circuit for lifting the boom when receiving hydraulic fluid under pressure from a conventional valve control and a lowering circuit for lowering the boom when receiving hydraulic fluid under pressure from a conventional valve control, and a conventional hydraulic circuit including a reservoir and a pump for supplying the hydraulic fluid under pressure from the reservoir to the lift cylinders, the system comprising:
a gauge wheel for attachment below each boom structure for pivoting the boom structure up and down relative to the frame as the gauge wheel rides along the ground;
a pressure reducing valve for communication with the lifting circuit of each cylinder and having a set point pressure whereby the pressure reducing valve maintains a controlled pressure in the lifting circuits substantially at the set point pressure by allowing hydraulic fluid to flow from the lifting circuits to the fluid reservoir when lowering of the boom by the gauge wheel increases hydraulic pressure at the lifting circuits above the set point pressure and by allowing hydraulic fluid to flow from the pump to the lifting circuits under pressure when raising of the boom by the gauge wheel decreases hydraulic pressure at the lifting circuits below the set point pressure;
a switch for selectively disconnecting the pressure reducing valve from the lifting circuits to allow normal operation of the lifting circuits by the conventional valve control;
a biasing mechanism for balancing the pressure reducing valve at the set point pressure;
a controller for controlling a biasing force applied to the pressure reducing valve by the biasing mechanism; and
a flow restrictor for connection in series with each lifting circuit between the conventional valve control and communication of the pressure reducing valve with the lifting circuit.

8. The system according to claim 7 wherein the flow restrictor connects in series with each lifting circuit upstream from communication of the pressure reducing valve with the lifting circuit in a lifting flow direction.

9. The system according to claim 7 wherein flow between the pressure reducing valve and the respective lift cylinder is unrestricted.

10. A boom control kit for a vehicle comprising a frame supported for rolling movement along the ground; an operator cab for supporting an operator of the vehicle therein; a pair of boom structures extending laterally outward from opposing sides of the frame for pivotal movement up and down relative to the frame; a lift cylinder coupled between each boom structure and the frame for lifting the boom structures, each lift cylinder including a lifting circuit for lifting the boom when receiving hydraulic fluid under pressure from a conventional valve control and a lowering circuit for lowering the boom when receiving hydraulic fluid under pressure from a conventional valve control, and a conventional hydraulic circuit including a reservoir and a pump for supplying the hydraulic fluid under pressure from the reservoir to the lift cylinders, the kit comprising:
a gauge wheel for attachment below each boom structure for pivoting the boom structure up and down relative to the frame as the gauge wheel rides along the ground;
a pressure reducing valve for communication with the lifting circuit of each cylinder and having a set point pressure whereby the pressure reducing valve maintains a controlled pressure in the lifting circuits substantially at the set point pressure by allowing hydraulic fluid to flow from the lifting circuits to the fluid reservoir when lowering of the boom by the gauge wheel increases hydraulic pressure at the lifting circuits above the set point pressure and by allowing hydraulic fluid to flow from the pump to the lifting circuits under pressure when raising of the boom by the gauge wheel decreases hydraulic pressure at the lifting circuits below the set point pressure;
a switch for selectively disconnecting the pressure reducing valve from the lifting circuits to allow normal operation of the lifting circuits by the conventional valve control;
a biasing mechanism for balancing the pressure reducing valve at the set point pressure;
a controller for controlling a biasing force applied to the pressure reducing valve by the biasing mechanism; and
a flow restrictor for connection in series with each lifting circuit between the conventional valve control and communication of the pressure reducing valve with the lifting circuit.

11. The kit according to claim 10 wherein the pressure reducing valve, the biasing mechanism and the flow restrictors are integrally mounted within a common housing for mounting on the frame of the vehicle.

12. A method of controlling a pair of boom structures in a vehicle comprising a frame supported for rolling movement along the ground; an operator cab for supporting an operator of the vehicle therein; pivotal mounts supporting the pair of boom structures extending laterally outward from opposing sides of the frame for pivotal movement up and down relative to the frame; a lift cylinder coupled between each boom structure and the frame for lifting the boom structures, each lift cylinder including a lifting circuit for lifting the boom when receiving hydraulic fluid under pressure from a conventional valve control and a lowering circuit for lowering the boom when receiving hydraulic fluid under pressure from a conventional valve control, and a conventional hydraulic circuit including a reservoir and a pump for supplying the hydraulic fluid under pressure from the reservoir to the lift cylinders, the method comprising:
attaching a gauge wheel below each boom structure for pivoting the boom structure up and down relative to the frame as the gauge wheel rides along the ground;
providing a pressure reducing valve and a biasing mechanism balancing the pressure reducing valve at a set point pressure;
providing a controller which controls the set point pressure by controlling a biasing force applied to the pressure reducing valve by the biasing mechanism;
connecting the pressure reducing valve in communication with the lifting circuit of each cylinder such that the pressure reducing valve maintains a controlled pressure in the lifting circuits substantially at the set point pressure by allowing hydraulic fluid to flow from the lifting circuits to the fluid reservoir when lowering of the boom by the gauge wheel increases hydraulic pressure at the lifting circuits above the set point pressure and by allowing hydraulic fluid to flow from the pump to the lifting circuits under pressure when raising of the boom by the gauge wheel decreases hydraulic pressure at the lifting circuits below the set point pressure;
providing a switch in series with connection of the pressure reducing valve to the lifting circuits to allow normal operation of the lifting circuits by the conventional valve control when the pressure reducing valve and the lifting circuits are disconnected by the switch; and
partially restricting flow in each lifting circuit between the conventional valve control and a point of communication of the pressure reducing valve with the lifting circuit.

13. In a vehicle comprising a frame supported for rolling movement along the ground; an operator cab for supporting an operator of the vehicle therein; a pair of boom structures extending laterally outward from opposing sides of the frame for pivotal movement up and down relative to the frame; a lift cylinder coupled between each boom structure and the frame for lifting the boom structures, each lift cylinder including a lifting circuit for lifting the boom when receiving hydraulic fluid under pressure from a conventional valve control and a lowering circuit for lowering the boom when receiving hydraulic fluid under pressure from a conventional valve control, and a conventional hydraulic circuit including a reservoir and a pump for supplying the hydraulic fluid under pressure from the reservoir to the lift cylinders, a boom control system comprising:
a gauge wheel attached below each boom structure for pivoting the boom structure up and down relative to the frame as the gauge wheel rides along the ground;
a pressure reducing valve in communication with the lifting circuit of each cylinder and having a set point pressure whereby the pressure reducing valve maintains a controlled pressure in the lifting circuits substantially at the set point pressure by allowing hydraulic fluid to flow from the lifting circuits to the fluid reservoir when lowering of the boom by the gauge wheel increases hydraulic pressure at the lifting circuits above the set point pressure and by allowing hydraulic fluid to flow from the pump to the lifting circuits under pressure when raising of the boom by the gauge wheel decreases hydraulic pressure at the lifting circuits below the set point pressure;
a switch selectively connecting the pressure reducing valve to the lifting circuits to allow normal operation of the lifting circuits by the conventional valve control when the pressure reducing valve and the lifting circuits are disconnected by the switch;
a biasing mechanism balancing the pressure reducing valve at the set point pressure;
a controller controlling a biasing force applied to the pressure reducing valve by the biasing mechanism; and
a flow restrictor connected in series with each lifting circuit between the conventional valve control and communication of the pressure reducing valve with the lifting circuit.
